(19) United States
(12) Patent Application Publication
(10) Pub. No.: US 2026/0217132 A1
(43) Pub. Date: Jul. 30, 2026

(54) VEHICLE CONTROL APPARATUS AND VEHICLE CONTROL METHOD

(71) Applicant: SUBARU CORPORATION, Tokyo (JP)

(72) Inventors: Yosuke TAKEBAYASHI, Tokyo (JP); Takeshi YONEDA, Tokyo (JP); Masaru KOGURE, Tokyo (JP); Masahiro SAITO, Tokyo (JP); Naoto YABUKI, Tokyo (JP); Norio OOWADA, Tokyo (JP)

(21) Appl. No.: 18/723,787

(22) PCT Filed: Feb. 10, 2023
(86) PCT No.: PCT/JP2023/004581

§ 371 Date: Jun. 24, 2024

(51) Int. Cl. B60L 15/20

(52) U.S. Cl. CPC B60L 15/20; B60L 2240/423; B60L 2240/465; B60L 2250/28

(57) ABSTRACT

A vehicle control apparatus according to an aspect of the disclosure is an apparatus configured to control a vehicle that travels by driving a motor. The vehicle control apparatus includes a control unit configured to derive a target torque by adding, to a requested torque corresponding to an acceleration request, a fluctuation torque that fluctuates cyclically, and control a torque of the motor, based on the derived target torque. The control unit is configured to control, based on the target torque, the torque of the motor, when any of a slip angle of the vehicle, a slip rate of the vehicle, and a road surface utilization rate of the vehicle is greater than a predetermined threshold.

### CROSS-REFERENCE TO RELATED APPLICATIONS

This application is the U.S. National Phase under 35 U.S.C. § 371 of International Application No. PCT/JP2023/004581, filed on Feb. 10, 2023.

### TECHNICAL FIELD

The disclosure relates to a vehicle control apparatus to be mounted on a vehicle and to a vehicle control method.

### BACKGROUND ART

Various techniques for safely operating a vehicle have been proposed (for example, see Patent Literatures 1 and 2).

### CITATION LIST

### Patent Literature

Patent Literature 1: Japanese Unexamined Patent Application Publication No. 2017-055618
Patent Literature 2: Japanese Unexamined Patent Application Publication No. 2011-205799

### SUMMARY OF INVENTION

An aspect of the disclosure provides a vehicle control apparatus configured to control a vehicle that travels by driving a motor. The vehicle control apparatus includes a control unit configured to derive a target torque by adding, to a requested torque corresponding to an acceleration request, a fluctuation torque that fluctuates cyclically, and control a torque of the motor, based on the derived target torque. The control unit is configured to control, based on the target torque, the torque of the motor, when any of a slip angle of the vehicle, a slip rate of the vehicle, and a road surface utilization rate of the vehicle is greater than a predetermined threshold.

An aspect of the disclosure provides a vehicle control method that controls a vehicle that travels by driving a motor. The vehicle control method includes two acts as follows.
(1) Deriving a target torque by adding, to a requested torque corresponding to an acceleration request, a fluctuation torque that fluctuates cyclically.
(2) Controlling, based on the derived target torque, a torque of the motor, when any of a slip angle of the vehicle, a slip rate of the vehicle, and a road surface utilization rate of the vehicle is greater than a predetermined threshold.

An aspect of the disclosure provides a vehicle control apparatus configured to control a vehicle that travels by driving a motor. The vehicle control apparatus includes circuitry configured to derive a target torque by adding, to a requested torque corresponding to an acceleration request, a fluctuation torque that fluctuates cyclically, and control a torque of the motor, based on the derived target torque. The circuitry is configured to control, based on the target torque, the torque of the motor, when any of a slip angle of the vehicle, a slip rate of the vehicle, and a road surface utilization rate of the vehicle is greater than a predetermined threshold.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an example of a functional block of a vehicle including a vehicle controller according to an embodiment of the disclosure.

FIG. 2 is a diagram illustrating an example of a procedure of deriving a target torque in a travel controller of FIG. 1.

FIG. 3 is a diagram illustrating an example of a procedure of a torque control in the travel controller of FIG. 1.

FIG. 4(A) is a diagram illustrating an example of a waveform of a requested torque. FIG. 4(B) is a diagram illustrating an example of a waveform of a slip angle. FIG. 4(C) is a diagram illustrating an example of a waveform of a fluctuation torque. FIG. 4(D) is a diagram illustrating an example of a waveform of the target torque.

FIG. 5 is a diagram illustrating an example of a relationship between the slip angle and a cornering force.

FIG. 6 is a diagram illustrating an example of the procedure of the torque control in the travel controller of FIG. 1.

FIG. 7(A) is a diagram illustrating an example of the waveform of the requested torque. FIG. 7(B) is a diagram illustrating an example of a waveform of a slip rate. FIG. 7(C) is a diagram illustrating an example of the waveform of the fluctuation torque. FIG. 7(D) is a diagram illustrating an example of the waveform of the target torque.

FIG. 8 is a diagram illustrating an example of a relationship between the slip rate and the cornering force.

FIG. 9 is a diagram illustrating an example of a relationship between the slip rate and a wheel longitudinal force.

FIG. 10 is a diagram illustrating an example of the procedure of the torque control in the travel controller of FIG. 1.

FIG. 11(A) is a diagram illustrating an example of the waveform of the requested torque. FIG. 11(B) is a diagram illustrating an example of a waveform of a road surface utilization rate. FIG. 11(C) is a diagram illustrating an example of the waveform of the fluctuation torque. FIG. 11(D) is a diagram illustrating an example of the waveform of the target torque.

FIG. 12 is a diagram illustrating a modification example of the functional block of the vehicle of FIG. 1.

### MODES FOR CARRYING OUT THE INVENTION

A vehicle that travels by motor driving is smoother in a motor output than an engine output, making it difficult for a driver to grasp a slip of the vehicle. Accordingly, the driver may not recognize a possibility of the slip of the vehicle, allowing the vehicle to be at risk. It is desirable to provide a vehicle control apparatus and a vehicle control method that make it possible to cause a driver to recognize a possibility of a slip of a vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Embodiment

### Configuration Example

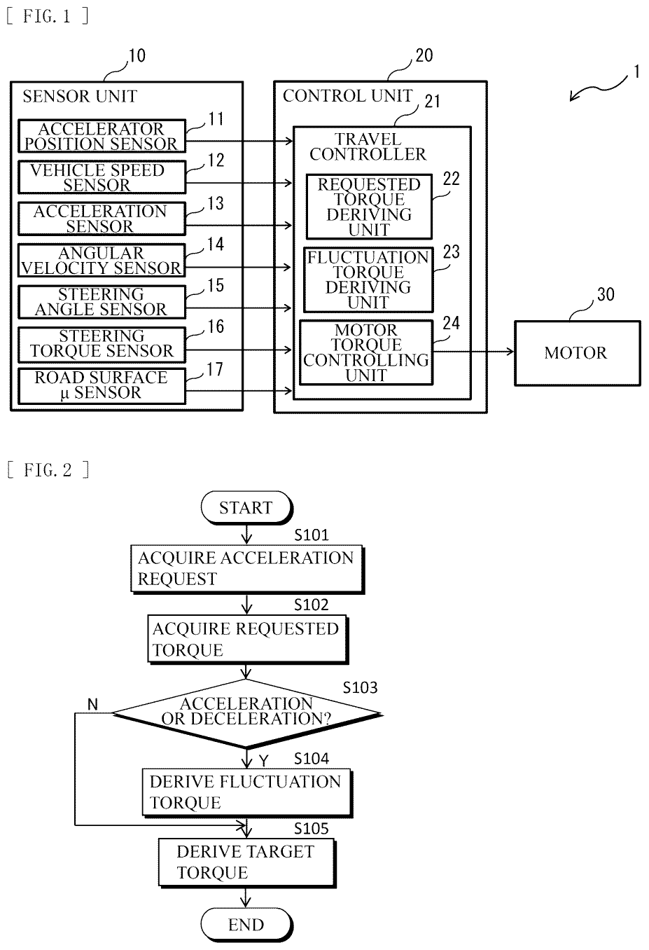

FIG. 1 illustrates a schematic configuration example of a vehicle 1 including a control unit 20 according to an embodiment of the disclosure. The control unit 20 corresponds to a specific example of a “control unit” according to the disclosure. The vehicle 1 is configured to travel by driving a motor. As illustrated in FIG. 1, the vehicle 1 includes, for example, a sensor unit 10, the control unit 20, and a motor 30.

The sensor unit 10 includes various sensors mounted on the vehicle 1. As illustrated in FIG. 1, the sensor unit 10 includes, for example, an accelerator position sensor 11, a vehicle speed sensor 12, an acceleration sensor 13, an angular velocity sensor 14, a steering angle sensor 15, a steering torque sensor 16, and a road surface friction coefficient sensor 17. The sensor unit 10 may include any sensor other than those described above.

The accelerator position sensor 11 is configured to detect an accelerator position, based on a depression amount of an accelerator pedal. The accelerator position sensor 11 is configured to output, to the control unit 20, time-series data (accelerator position data) on the detected accelerator position.

The vehicle speed sensor 12 is configured to detect a speed (a vehicle speed) of the vehicle 1. The vehicle speed sensor 12 is configured to output, to the control unit 20, time-series data (vehicle speed data) on the detected vehicle speed. The acceleration sensor 13 is configured to detect an acceleration applied to the vehicle 1. The acceleration sensor 13 is configured to output, to the control unit 20, time-series data (acceleration data) on the detected accelerations in three directions. The angular velocity sensor 14 is configured to detect an angular velocity of the vehicle 1. The angular velocity sensor 14 is configured to output, to the control unit 20, time-series data (angular velocity data) on the three detected angular velocities (a yaw angular velocity, a roll angular velocity, and a pitch angular velocity).

The steering angle sensor 15 is configured to detect a steering angle (a steering angle) of a steering wheel of the vehicle 1. The steering angle sensor 15 is configured to output, to the control unit 20, time-series data (steering angle data) on the detected steering angle. The steering torque sensor 16 is configured to detect the steering torque generated by a steering operation performed by a driver. The steering torque sensor 16 is configured to output, to the control unit 20, time-series data (steering torque data) on the detected steering torque.

The road surface friction coefficient sensor 17 is configured to estimate, for example, a friction coefficient of a road surface in front of the vehicle 1. The road surface friction coefficient sensor 17 includes, for example, a non-contact sensor such as a camera that captures an image of the front of the vehicle 1, a temperature sensor (an outside air temperature sensor or a road surface temperature sensor), a near-infrared sensor, or a laser-light sensor (TOF (Time of Flight) sensor. The road surface friction coefficient sensor 17 is configured to estimate the road surface friction coefficient, based on, for example, a detection result of the non-contact sensor. The road surface friction coefficient sensor 17 is configured to output, to the control unit 20, time-series data (road surface friction coefficient data) on the road surface friction coefficient obtained by the estimation. The road surface friction coefficient sensor 17 may be, for example, a road surface sensor that directly measures the road surface friction coefficient.

The control unit 20 is configured to control the vehicle 1 as a whole. The control unit 20 is, for example, a so-called ECU (Electronic Control Unit), and includes, for example, one or more processors and one or more memories. The control unit 20 may include, for example, a CPU (Central Processing Unit). The control unit 20 is configured to control the vehicle 1 as a whole by, for example, executing a program stored in a storage.

The control unit 20 is configured to control the vehicle 1 that travels by driving the motor. The control unit 20 includes, for example, a travel controller 21 as illustrated in FIG. 1. The travel controller 21 is configured to control traveling of the vehicle 1 (for example, a torque of the motor 30). As illustrated in FIG. 1, the travel controller 21 includes, for example, a requested torque deriving unit 22, a fluctuation torque deriving unit 23, and a motor torque controlling unit 24.

The requested torque deriving unit 22 is configured to derive a requested torque corresponding to an acceleration request. The acceleration request refers to a depression of the accelerator pedal or a variation in the depression amount of the accelerator pedal. The acceleration request may be made by the driver during manual driving, or may be made by the travel controller 21 during automated driving. The requested torque deriving unit 22 is configured to derive a torque amount (the requested torque) to be generated by the motor 30, based on the accelerator position data obtained by the accelerator position sensor 11.

The fluctuation torque deriving unit 23 is configured to derive the fluctuation torque that fluctuates cyclically. The fluctuation torque is to cause the driver to recognize a possibility of a slip of the vehicle 1 by intentionally changing a behavior of the vehicle 1. For example, the fluctuation torque deriving unit 23 may be configured to cause a fluctuation range, a cycle, and a waveform of the fluctuation torque to be constant regardless of a magnitude of the requested torque. The fluctuation torque deriving unit 23 may be configured to derive, for example, the fluctuation torque of the fluctuation range having a magnitude of 10% of the magnitude of the requested torque.

The motor torque controlling unit 24 is configured to derive the target torque by adding the fluctuation torque to the requested torque, and control the torque of the motor 30 based on the derived target torque. The motor torque controlling unit 24 is configured to calculate a slip angle β of the vehicle 1, based on the sensor data obtained by the sensor unit 10.

The motor torque controlling unit 24 is configured to control, based on the target torque, the torque of the motor 30, when the calculated slip angle β is greater than a predetermined threshold. The motor torque controlling unit 24 is configured to control the torque of the motor 30 based on the requested torque as the target torque, when the calculated slip angle β is equal to or less than the predetermined threshold. The motor torque controlling unit 24 is configured to output, to the motor 30, the target torque as a control signal.

The motor 30 is configured to drive steered wheels of the vehicle 1. The motor 30 is configured to drive the steered wheels of the vehicle 1 in accordance with the target torque inputted from the motor torque controlling unit 24. As used herein, the term “steered wheels” refers to front wheels, rear wheels, or both.

### [Operation]

Next, an operation of the travel controller 21 will be described with reference to FIG. 2. FIG. 2 is a diagram illustrating an example of a procedure of deriving the target torque.

The travel controller 21 acquires the acceleration request from the accelerator position sensor 11 (step S101). Next, when the acceleration request is acquired from the accelerator position sensor 11 (step S102), the travel controller 21 derives the fluctuation torque (step S104) if the acquired acceleration request is a request for acceleration or a request for deceleration (step S103: Y). If the acquired acceleration request is not the request for acceleration or the request for deceleration (step S103: N), or when the fluctuation torque is derived in step S104, the travel controller 21 derives the target torque (step S105). When the acquired acceleration request is not the request for acceleration or the request for deceleration, the travel controller 21 sets, as the target torque, the requested torque corresponding to the acceleration request. When the fluctuation torque is derived in step S104, the travel controller 21 derives the target torque by adding, to the requested torque corresponding to the acceleration request, the fluctuation torque that fluctuates cyclically.

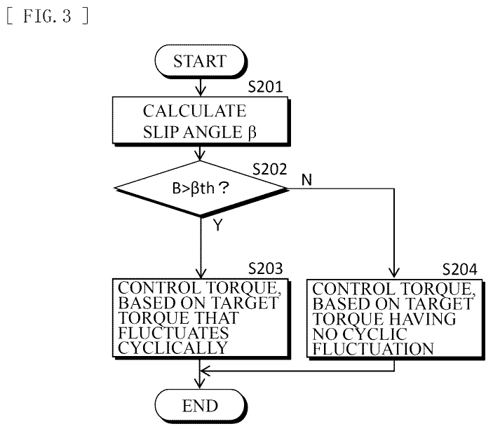

Next, the torque control based on the derived target torque will be described with reference to FIG. 3. FIG. 3 is a diagram illustrating an example of a procedure of the torque control in the travel controller 21.

First, the travel controller 21 calculates the slip angle β, based on the sensor data obtained by the sensor unit 10 (step S201). Next, the travel controller 21 determines whether the calculated slip angle β is greater than the predetermined threshold βth (step S202). If the slip angle β is greater than the predetermined threshold βth (step S202: Y), the travel controller 21 controls the torque of the motor 30, based on the target torque that fluctuates cyclically (step S203). If the slip angle β is equal to or less than the predetermined threshold βth (step S202: N), the travel controller 21 controls the torque of the motor 30, based on the target torque having no cyclic fluctuation (step S204). In this way, the torque control based on the derived target torque is performed.

### [Effect]

Next, an effect of the control unit 20 according to an embodiment of the disclosure will be described.

In the present embodiment, the target torque is derived by adding, to the requested torque corresponding to the acceleration request, the fluctuation torque that fluctuates cyclically, and the torque of the motor 30 is controlled based on the derived target torque. At this time, the torque of the motor 30 is controlled based on the target torque, when the slip angle β obtained by the sensor unit 10 mounted on the vehicle 1 is greater than the predetermined threshold. Thus, the steered wheels of the vehicle 1 are driven in accordance with the target torque, and the behavior of the vehicle 1 is varied in accordance with the target torque.

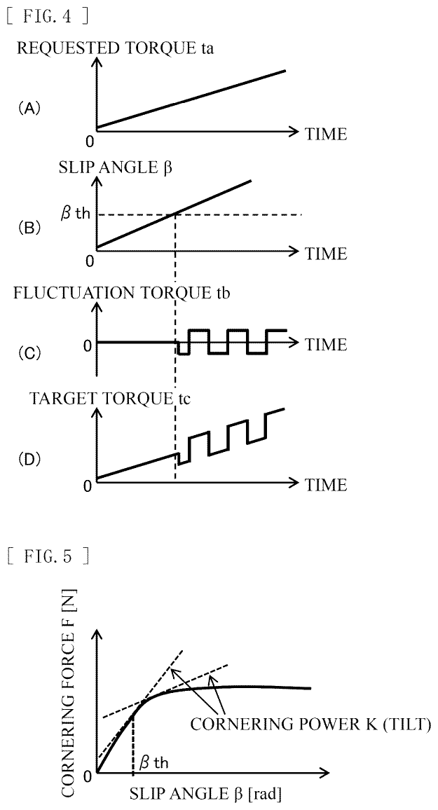

FIG. 4(A) illustrates an example of a waveform of the requested torque ta. FIG. 4 (B) illustrates an example of a waveform of the slip angle β. FIG. 4(C) illustrates an example of a waveform of the fluctuation torque tb. FIG. 4(D) illustrates an example of a waveform of the target torque tc.

It is assumed that the requested torque ta increases with time, and the slip angle β also increases with time (FIG. 4(A) and FIG. 4(B)). At this time, when the slip angle β exceeds the threshold βth at a certain time, the target torque tc having the waveform in which the fluctuation torque tb is added to the requested torque ta is generated (FIG. 4(C) and FIG. 4(D)). The travel controller 21 outputs, to the motor 30, the target torque tc having the waveform as illustrated in FIG. 4(D). Thus, the motor 30 drives the steered wheels of the vehicle 1 in accordance with the target torque tc inputted from the travel controller 21. Accordingly, the behavior of the vehicle 1 varies in accordance with the target torque tc.

Here, a cornering force F also increases as the slip angle β increases as illustrated in FIG. 5, for example. However, around a timing at which the slip angle β has exceeded a certain value, an increase ratio of the cornering force F to the slip angle β becomes gradual. This means that the wheels start to slip as the slip angle β increases. When such a slip of the wheels occurs, the driver feels that the vehicle 1 does not accelerate as much as expected for the amount of depression of the accelerator. However, after the driver recognizes the slip of the wheels, there is a possibility that the vehicle 1 is at risk.

Accordingly, in the present embodiment, the travel controller 21 is configured to output, to the motor 30, the target torque tc that fluctuates cyclically, at a timing before a timing at which the driver feels that the vehicle 1 does not accelerate as much as expected for a magnitude of the depression of the accelerator. To allow for such a control, the threshold βth is at a value of the slip angle β that is at a timing before the timing at which the driver feels that the vehicle 1 does not accelerate as much as expected for the magnitude of the depression of the accelerator.

Incidentally, the cornering force F is a mathematical function of the slip angle β as illustrated in FIG. 5, for example. The tangent (a dashed line in the figure) to the mathematical function corresponds to cornering power K. That is, an amount of change (ΔF/ΔB) of the cornering force F with respect to the slip angle β corresponds to the cornering power K. When the cornering power K is large, the cornering force F greatly changes simply in response to a slight change in the slip angle β. However, when the slip angle β is greater than the certain value, the cornering power K is rapidly decreased as illustrated in FIG. 5, for example. As the cornering power K decreases, an amount of increase in the cornering force F with respect to the change in the slip angle β decreases. This causes a phenomenon in which “the driver feels that the vehicle 1 does not accelerate as much as expected for the amount of depression of the accelerator”.

Accordingly, in the present embodiment, the slip angle β at the timing before the timing at which the driver feels that the vehicle 1 does not accelerate as much as expected for the amount of depression of the accelerator is set as the threshold βth, and the travel controller 21 is configured to control, based on the target torque that fluctuates cyclically, the torque of the motor 30 when the slip angle β is greater than the threshold βth. The threshold βth has a value greater than 0 and less than the slip angle β at which the cornering power K takes a negative value. Accordingly, it is possible to cause the driver to recognize the possibility of the slip of the vehicle 1 before the vehicle 1 is at risk.

### 2. Modification Examples

Although the disclosure has been described with reference to an embodiment, the disclosure is not limited to the embodiment, and various modifications can be made.

### Modification Example A

In the above-described embodiment, the motor torque controlling unit 24 may be configured to calculate a slip rate λ instead of the slip angle β. For example, the slip rate 2 is calculated as (Vw−V)/Vw at the time of acceleration and calculated as (V−Vw)/Vw at the time of deceleration. V denotes a vehicle body speed, and Vw denotes a wheel speed.

The motor torque controlling unit 24 is configured to control, based on the target torque, the torque of the motor 30, when the calculated slip rate λ is greater than a predetermined threshold. When the calculated slip rate λ is equal to or less than the predetermined threshold, the motor torque controlling unit 24 is configured to control the torque of the motor 30, based on the requested torque as the target torque. The motor torque controlling unit 24 is configured to output, to the motor 30, the target torque as the control signal.

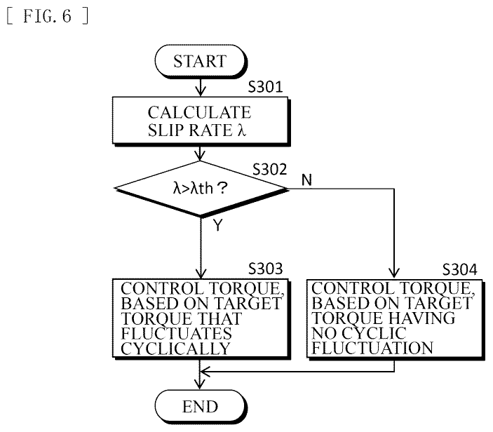

Next, the torque control based on the derived target torque will be described with reference to FIG. 6. FIG. 6 is a diagram illustrating an example of the procedure of the torque control in the travel controller 21.

First, the travel controller 21 calculates the slip rate 2, based on the sensor data obtained by the sensor unit 10 (step S301). Next, the travel controller 21 determines whether the calculated slip rate λ is greater than the predetermined threshold λth (step S302). If the slip rate λ is greater than the predetermined threshold λth (step 302: Y), the travel controller 21 controls the torque of the motor 30, based on the target torque that fluctuates cyclically (step S303). If the slip rate λ is equal to or less than the predetermined threshold λth (step S302: N), the travel controller 21 controls the torque of the motor 30, based on the target torque having no cyclic fluctuation (step S304). In this way, the torque control based on the derived target torque is performed.

Next, an effect of the control unit 20 according to the present modification example will be described.

In the present modification example, the target torque is derived by adding, to the requested torque corresponding to the acceleration request, the fluctuation torque that fluctuates cyclically, and the torque of the motor 30 is controlled based on the derived target torque. At this time, the torque of the motor 30 is controlled based on the target torque, when the slip rate 2 obtained by the sensor unit 10 mounted on the vehicle 1 is greater than the predetermined threshold. Thus, the steered wheels of the vehicle 1 are driven in accordance with the target torque, and the behavior of the vehicle 1 is varied in accordance with the target torque.

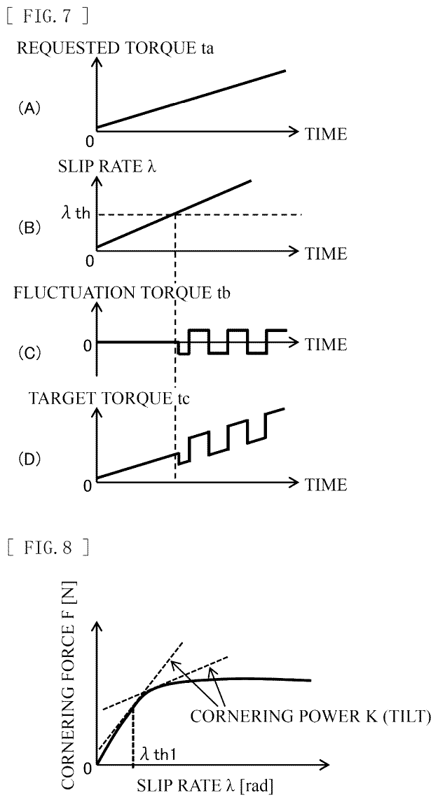

FIG. 7(A) illustrates an example of the waveform of the requested torque ta. FIG. 7 (B) illustrates an example of a waveform of the slip rate λ. FIG. 7(C) illustrates an example of the waveform of the fluctuation torque tb. FIG. 7(D) illustrates an example of the waveform of the target torque tc.

It is assumed that the requested torque ta increases with time, and the slip rate λ also increases with time (FIG. 7(A) and FIG. 7(B)). At this time, when the slip rate λ exceeds the threshold λth at a certain time, the target torque tc having the waveform in which the fluctuation torque tb is added to the requested torque ta is generated (FIG. 7(C) and FIG. 7(D)). The travel controller 21 outputs, to the motor 30, the target torque tc having the waveform as illustrated in FIG. 7(D). Thus, the motor 30 drives the steered wheels of the vehicle 1 in accordance with the target torque tc inputted from the travel controller 21. Accordingly, the behavior of the vehicle 1 varies in accordance with the target torque tc.

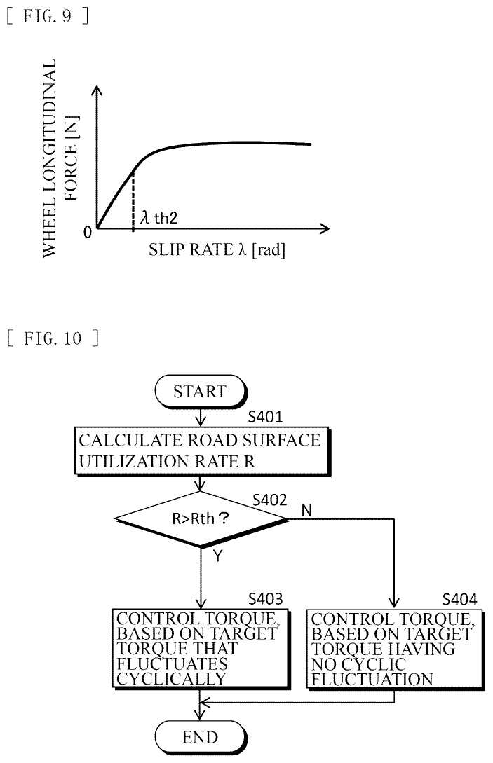

Here, for example, upon turning the steering wheel and taking a corner as illustrated in FIG. 8, the cornering force F does not increase with an increase in the slip rate λ, and the cornering power K decreases. This means that it becomes gradually difficult for the vehicle 1 to turn with the increase in the slip rate λ. Further, for example, in a state in which the steering wheel is not turned to travel straight as illustrated in FIG. 9, a wheel longitudinal force does not increase with the increase in the slip rate λ. This means that it becomes gradually difficult for the vehicle 1 to accelerate with the increase in the slip rate λ. However, after the driver recognizes that it becomes gradually difficult for the vehicle 1 to turn or accelerate, there is a possibility that the vehicle 1 is at risk.

Incidentally, the cornering force F is a mathematical function of the slip rate λ as illustrated in FIG. 8, for example. The tangent (a dashed line in the figure) to the mathematical function corresponds to the cornering power K. That is, an amount of change (ΔF/Δλ) of the cornering force F with respect to the slip rate λ corresponds to the cornering power K. When the cornering power K is large, the cornering force F greatly changes simply in response to a slight change in the slip rate λ. However, when the slip rate λ is greater than a certain value, the cornering power K is rapidly decreased as illustrated in FIG. 8, for example. As the cornering power K decreases, an amount of increase in the cornering force F with respect to the change in the slip rate λ decreases. This causes a phenomenon in which “the driver feels that the vehicle 1 does not accelerate as much as expected for the amount of depression of the accelerator”.

Accordingly, in the present modification example, the slip rate λ at a timing before the timing at which the driver feels that the vehicle 1 does not turn as much as expected for an amount of turning of the steering wheel is set as a threshold λth1, and the travel controller 21 is configured to control, based on the target torque that fluctuates cyclically, the torque of the motor 30 when the slip rate λ is greater than the threshold λth1. Accordingly, it is possible to cause the driver to recognize the possibility of the slip of the vehicle 1 before the vehicle 1 is at risk.

Further, in the present modification example, the slip rate λ at a timing before the timing at which the driver feels that the vehicle 1 does not accelerate as much as expected for the amount of depression of the accelerator is set as a threshold λth2, and the travel controller 21 is configured to control, based on the target torque that fluctuates cyclically, the torque of the motor 30 when the slip rate λ is greater than the threshold λth2. Accordingly, it is possible to cause the driver to recognize the possibility of the slip of the vehicle 1 before the vehicle 1 is at risk.

### Modification Example B

In the above-described embodiment, the motor torque controlling unit 24 may be configured to calculate a road surface utilization rate R instead of the slip angle β. The road surface utilization rate R is calculated by the following Expression (1).

$$R = \frac{\sqrt{{Fx}^{2} + {Fy}^{2}}}{μ Fz} \qquad [ Mathematical 1 ]$$

Fx denotes the wheel longitudinal force [N], and is calculated by, for example, inputting the sensor data obtained from the sensor unit 10 into a magic formula, for example. Fy denotes a wheel lateral force (the cornering force) [N], and is calculated, for example, by inputting the sensor data obtained from the sensor unit 10 into a magic formula, for example. Fz denotes a wheel-ground load [N], and is obtained by a vehicle model, for example.

The motor torque controlling unit 24 is configured to control, based on the target torque, the torque of the motor 30, when the calculated road surface utilization rate R is greater than a predetermined threshold. When the calculated road surface utilization rate R is equal to or less than the predetermined threshold, the motor torque controlling unit 24 is configured to control the torque of the motor 30, based on the requested torque as the target torque. The motor torque controlling unit 24 is configured to output, to the motor 30, the target torque as the control signal.

Next, the torque control based on the derived target torque will be described with reference to FIG. 10. FIG. 10 is a diagram illustrating an example of the procedure of the torque control in the travel controller 21.

First, the travel controller 21 calculates the road surface utilization rate R, based on the sensor data obtained by the sensor unit 10 (step S401). Next, the travel controller 21 determines whether the calculated road surface utilization rate R is greater than the predetermined threshold Rth (step S402). If the road surface utilization rate R is greater than the predetermined threshold Rth (step 402: Y), the travel controller 21 controls the torque of the motor 30, based on the target torque that fluctuates cyclically (step S403). If the road surface utilization rate R is equal to or less than the predetermined threshold Rth (step S402: N), the travel controller 21 controls the torque of the motor 30, based on the target torque having no cyclic fluctuation (step S404). In this way, the torque control based on the derived target torque is performed.

Next, an effect of the control unit 20 according to the present modification example will be described.

In the present modification example, the target torque is derived by adding, to the requested torque corresponding to the acceleration request, the fluctuation torque that fluctuates cyclically, and the torque of the motor 30 is controlled based on the derived target torque. At this time, the torque of the motor 30 is controlled based on the target torque, when the road surface utilization rate R obtained by the sensor unit 10 mounted on the vehicle 1 is greater than the predetermined threshold. Thus, the steered wheels of the vehicle 1 are driven in accordance with the target torque, and the behavior of the vehicle 1 is varied in accordance with the target torque.

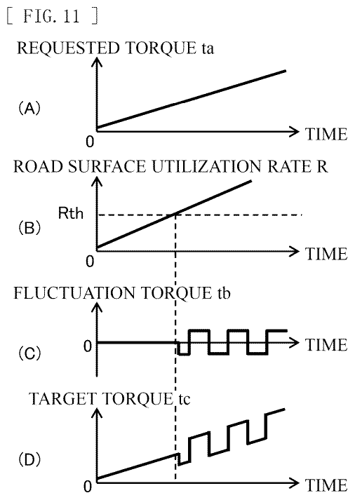

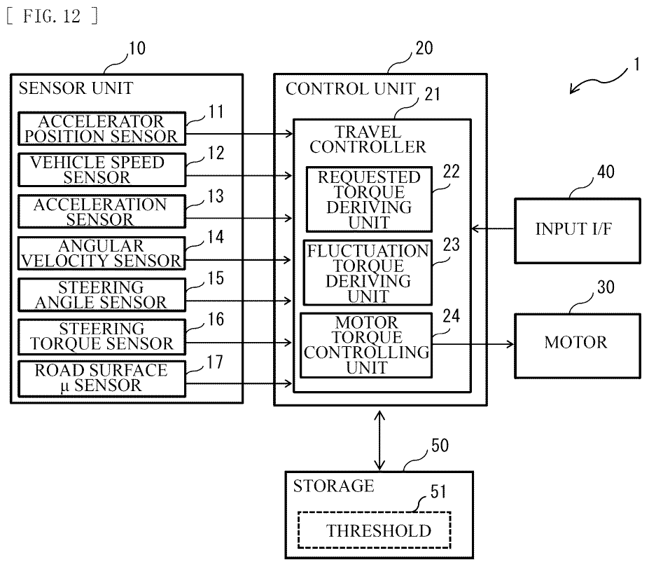

FIG. 11(A) illustrates an example of the waveform of the requested torque ta. FIG. 11(B) illustrates an example of a waveform of the road surface utilization rate R. FIG. 11(C) illustrates an example of the waveform of the fluctuation torque tb. FIG. 11(D) illustrates an example of the waveform of the target torque tc.

It is assumed that the requested torque ta increases with time, and the road surface utilization rate R also increases with time (FIG. 11(A) and FIG. 11(B)). At this time, when the road surface utilization rate R exceeds the threshold Rth at a certain time, the target torque tc having the waveform in which the fluctuation torque tb is added to the requested torque ta is generated (FIG. 11(C) and FIG. 11(D)). The travel controller 21 outputs, to the motor 30, the target torque tc having the waveform as illustrated in FIG. 11(D). Thus, the motor 30 drives the steered wheels of the vehicle 1 in accordance with the target torque tc inputted from the travel controller 21. Accordingly, the behavior of the vehicle 1 varies in accordance with the target torque tc.

Here, the cornering force F also increases as the road surface utilization rate R increases. However, around a timing at which the road surface utilization rate R has exceeded a certain value, an increase ratio of the cornering force F to the road surface utilization rate R becomes gradual. This means that the wheels start to slip as the road surface utilization rate R increases. When such a slip of the wheels occurs, the driver feels that the vehicle 1 does not accelerate as much as expected for the amount of depression of the accelerator. However, after the driver recognizes the slip of the wheels, there is a possibility that the vehicle 1 is at risk.

Accordingly, in the present modification example, the travel controller 21 is configured to output, to the motor 30, the target torque tc that fluctuates cyclically, at a timing before the timing at which the driver feels that the vehicle 1 does not accelerate as much as expected for a magnitude of the depression of the accelerator. To allow for such a control, the threshold Rth is at a value of the road surface utilization rate R that is at a timing before the timing at which the driver feels that the vehicle 1 does not accelerate as much as expected for the magnitude of the depression of the accelerator.

In the present modification example, the travel controller 21 is configured to control, based on the target torque that fluctuates cyclically, the torque of the motor 30, when the road surface utilization rate R is greater than the threshold Rth, where the threshold Rth has any value in which the road surface utilization rate R is greater than 0 and less than 1. Accordingly, it is possible to cause the driver to recognize the possibility of the slip of the vehicle 1 before the vehicle 1 is at risk.

### Modification Example C

In the above-described embodiment and modification examples thereof, the vehicle 1 may further include an input I/F 40 that accepts an input from a user such as the driver and a storage 50 that stores the input accepted by the input I/F 40 as illustrated in FIG. 12, for example.

The input I/F 40 includes an input device such as a keyboard, a mouse, or a touch panel, for example. The storage 50 includes, for example, a RAM (Random Access Memory), a ROM (Read Only Memory), and a secondary storage device (such as a hard disk). For example, the input I/F 40 receives an input of a threshold 51 from the user such as the driver, and outputs the received threshold 51 to the travel controller 21. The travel controller 21 stores, in the storage 50, the threshold 51 acquired from the user, such as driver, via the input I/F 40. The storage 50 stores the threshold 51. For example, the threshold 51 is the threshold βth, the threshold λth, the threshold λth1, the threshold λth2, or the threshold Rth.

For example, when the calculated slip angle β is greater than the threshold βth read from the storage 50, the travel controller 21 may be configured to control the torque of the motor 30, based on the target torque that fluctuates cyclically (step S203). For example, when the calculated slip angle β is equal to or less than the threshold βth read from the storage 50, the travel controller 21 may be configured to control the torque of the motor 30, based on the target torque having no cyclic fluctuation (step S204).

For example, when the calculated slip rate λ is greater than the threshold (the threshold λth, the threshold λth1, or the threshold λth2) read from the storage 50, the travel controller 21 may be configured to control the torque of the motor 30, based on the target torque that fluctuates cyclically (step S303). For example, when the calculated slip rate λ is equal to or less than the threshold (the threshold λth, the threshold λth1, or the threshold λth2) read from the storage 50, the travel controller 21 may be configured to control the torque of the motor 30, based on the target torque having no cyclic fluctuation (step S304).

For example, when the calculated road surface utilization rate R is greater than the threshold Rth read from the storage 50, the travel controller 21 may be configured to control the torque of the motor 30, based on the target torque that fluctuates cyclically (step S403). For example, when the calculated road surface utilization rate R is equal to or less than the threshold Rth read from the storage 50, the travel controller 21 may be configured to control the torque of the motor 30, based on the target torque having no cyclic fluctuation (step S404).

In the present modification example as described above, the presence or absence of the cyclic fluctuation with respect to the torque is set based on the threshold inputted from the user such as the driver. Accordingly, it is possible to cause user such as the driver to recognize the possibility of the slip of the vehicle 1 before the vehicle 1 is at risk.

### Modification Example D

In the above-described embodiment and modification examples thereof, the travel controller 21 may set the presence or absence of the cyclic fluctuation with respect to the torque, based on a threshold set in accordance with a driving characteristic of the driver, for example.

For example, when the calculated slip angle β is greater than the threshold βth set in accordance with the driving characteristic of the driver, the travel controller 21 may be configured to control the torque of the motor 30, based on the target torque that fluctuates cyclically (step S203). For example, when the calculated slip angle β is equal to or less than the threshold βth set in accordance with the driving characteristic of the driver, the travel controller 21 may be configured to control the torque of the motor 30, based on the target torque having no cyclic fluctuation (step S204).

For example, when the calculated slip rate λ is greater than the threshold (the threshold λth, the threshold λth1, or the threshold λth2) set in accordance with the driving characteristic of the driver, the travel controller 21 may be configured to control the torque of the motor 30, based on the target torque that fluctuates cyclically (step S304). For example, when the calculated slip rate λ is equal to or less than the threshold (the threshold λth, the threshold λth1, or the threshold λth2) set in accordance with the driving characteristic of the driver, the travel controller 21 may be configured to control the torque of the motor 30, based on the target torque having no cyclic fluctuation (step S204).

For example, when the calculated road surface utilization rate R is greater than the threshold Rth set in accordance with the driving characteristic of the driver, the travel controller 21 may be configured to control the torque of the motor 30, based on the target torque that fluctuates cyclically (step S403). For example, when the calculated road surface utilization rate R is equal to or less than the threshold Rth set in accordance with the driving characteristic of the driver, the travel controller 21 may be configured to control the torque of the motor 30, based on the target torque having no cyclic fluctuation (step S404).

In the present modification example as described above, the presence or absence of the cyclic fluctuation with respect to the torque is set based on the threshold set in accordance with the driving characteristic of the driver. Accordingly, it is possible to cause the driver to recognize the possibility of the slip of the vehicle 1 before the vehicle 1 is at risk.

The effects described herein are merely examples, and the effects of the disclosure are not limited to the effects described herein. Accordingly, the disclosure may achieve other effects.

Further, the disclosure may take the following aspects.

A vehicle control apparatus that controls a vehicle that travels by driving a motor, the vehicle control apparatus including
a control unit configured to derive a target torque by adding, to a requested torque corresponding to an acceleration request, a fluctuation torque that fluctuates cyclically, and control a torque of the motor, based on the derived target torque, in which
the control unit is configured to control, based on the target torque, the torque of the motor, when any of a slip angle of the vehicle, a slip rate of the vehicle, and a road surface utilization rate of the vehicle is greater than a predetermined threshold.
   (2)

The vehicle control apparatus according to (1), in which the threshold includes a threshold inputted from a driver.

(3)

The vehicle control apparatus according to (1), in which the threshold includes a threshold set in accordance with a driving characteristic of a driver.

(4)

The vehicle control apparatus according to (1), in which the threshold includes a slip angle including a value that is greater than 0 and less than the slip angle at which cornering power takes a negative value.

(5)

The vehicle control apparatus according to (1), in which the threshold includes a road surface utilization rate including any value in which the road surface utilization rate is greater than 0 and less than 1.

(6)

A vehicle control method that controls a vehicle that travels by driving a motor, the vehicle control method including:
deriving a target torque by adding, to a requested torque corresponding to an acceleration request, a fluctuation torque that fluctuates cyclically; and
controlling, based on the derived target torque, a torque of the motor, when any of a slip angle of the vehicle, a slip rate of the vehicle, and a road surface utilization rate of the vehicle is greater than a predetermined threshold.

The control unit 20 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 20 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 20 illustrated in FIG. 1.

1. A vehicle control apparatus configured to control a vehicle that travels by driving a motor, the vehicle control apparatus comprising
a control unit configured to derive a target torque by adding, to a requested torque corresponding to an acceleration request, a fluctuation torque that fluctuates cyclically, and control a torque of the motor, based on the derived target torque, wherein
the control unit is configured to control, based on the target torque, the torque of the motor, when any of a slip angle of the vehicle, a slip rate of the vehicle, and a road surface utilization rate of the vehicle is greater than a predetermined threshold.

2. The vehicle control apparatus according to claim 1, wherein the threshold comprises a threshold inputted from a driver.

3. The vehicle control apparatus according to claim 1, wherein the threshold comprises a threshold set in accordance with a driving characteristic of a driver.

4. The vehicle control apparatus according to claim 1, wherein the threshold comprises the slip angle comprising a value that is greater than 0 and less than the slip angle at which cornering power takes a negative value.

5. The vehicle control apparatus according to claim 1, wherein the threshold comprises the road surface utilization rate comprising any value in which the road surface utilization rate is greater than 0 and less than 1.

6. A vehicle control method that controls a vehicle that travels by driving a motor, the vehicle control method comprising:
deriving a target torque by adding, to a requested torque corresponding to an acceleration request, a fluctuation torque that fluctuates cyclically; and
controlling, based on the derived target torque, a torque of the motor, when any of a slip angle of the vehicle, a slip rate of the vehicle, and a road surface utilization rate of the vehicle is greater than a predetermined threshold.

7. A vehicle control apparatus configured to control a vehicle that travels by driving a motor, the vehicle control apparatus comprising
circuitry configured to derive a target torque by adding, to a requested torque corresponding to an acceleration request, a fluctuation torque that fluctuates cyclically, and control a torque of the motor, based on the derived target torque, wherein
the circuitry is configured to control, based on the target torque, the torque of the motor, when any of a slip angle of the vehicle, a slip rate of the vehicle, and a road surface utilization rate of the vehicle is greater than a predetermined threshold.
